(19) United States
(12) Patent Application Publication
(10) Pub. No.: US 2015/0289041 A1
(43) Pub. Date: Oct. 8, 2015

(54) MODULAR WALL MOUNTING ASSEMBLY

(71) Applicant: Roswell Wake-Air Enterprises, Inc., Acheson (CA)

(72) Inventor: Robert Oswell, Acheson (CA)

(21) Appl. No.: 14/661,620

(22) Filed: Mar. 18, 2015

Related U.S. Application Data
(60) Provisional application No. 61/954,762, filed on Mar. 18, 2014.

(51) Int. Cl. H04R 1/02

(52) U.S. Cl. CPC H04R 1/02

(57) ABSTRACT

An apparatus including a control module including a power module configured to be coupled to a line voltage source and to provide a power distribution output, and an audio module configured to receive a source audio input signal and to provide an audio output signal. The apparatus also includes a modular track feature including a plurality of power distribution rails and one or more audio distribution conductors. The apparatus also includes a lighting device configured to physically couple with the modular track feature and electrically couple with at least a portion of the plurality of power distribution rails for powering the lighting device. The apparatus further includes a speaker configured to physically couple with the modular track feature and electrically couple with the audio distribution conductors for receiving the audio output signal from the control module.

### CROSS-REFERENCE TO RELATED APPLICATIONS

This application claims the benefit of U.S. provisional patent application Ser. No. 61/954,762, filed on Mar. 18, 2014, the entire disclosure of which is incorporated herein by reference.

### TECHNICAL FIELD

The present disclosure generally relates to wall mounting systems, and more particularly relates to modular wall mounting systems providing power and audio distribution.

### BACKGROUND

Individuals may commonly seek to express their personal stylistic tastes and preferences through the design and decoration of living spaces and work places. In addition to furnishings, such as tables, chairs, and desks, various pieces of interior decor may be selected to achieve a desired mix between functional needs and aesthetic desires. Example of such pieces of interior decor may include lamps, sounds systems, shelving units, entertainment electronics, and the like. At times an individual's design choices may be hampered by considerations such as the ability to install features in a desired location, or an interest in reducing unsightly wires that are often associated with modern electronics, such as computers and audio-visual equipment. As a result, compromises may often be forced on an individual, that may leave him short of achieving his desired design objectives.

### SUMMARY OF DISCLOSURE

According to an implementation, a modular wall mounting system may include a control module including a power module configured to be coupled to a line voltage source and to provide a power distribution output. The control module may also include an audio module configured to receive a source audio input signal and to provide an audio output signal. The modular wall mounting system may also include a modular track feature. The modular track feature may include a plurality of power distribution rails configured to be coupled with the power module and one or more audio distribution conductors configured to be coupled with the audio module. At least a portion of the power distribution rails may be exposed for contact coupling with a power consumption device. The modular wall mounting system may also include a lighting device configured to physically couple with the modular track feature and electrically couple with at least a portion of the plurality of power distribution rails for powering the lighting device. The modular wall mounting system may further include a speaker configured to physically couple with the modular track feature and electrically couple with the audio distribution conductors for receiving the audio output signal from the control module.

One or more of the following features may be included. The audio module may include an audio amplifier receiving the audio input signal from one or more of a tuner, a CD player, a DVD player; and a digital music player. The control module may further include a computing network module. The modular track feature may include one or more data distribution lines coupled with the computing network module. The one or more data distribution lines may be configured to couple with one or more remote computing devices.

The control module may be configured to interact with an external computing device. The control module configured to interact with the external computing device may be configured to receive streaming audio from the external computing device. The control module configured to interact with the external computing device may be configured to receive lighting control inputs from the external computing device. The control module may be configured to control the lighting device based upon the received lighting control inputs.

The modular track feature may include a plurality of modular track sections. Each of the modular track sections may physically and electrically coupleable to one or more adjacent modular track sections. The modular track feature may include a plurality of aesthetic trim components removably coupleable to an exterior surface of the modular track feature.

The plurality of power distribution rails may include power distribution rails providing different voltages. The plurality of audio distribution conductors may include a wiring assembly at least partially disposed within the modular track feature. The plurality of audio distribution conductors may include a plurality of conductive rails having at least one exposed surface for electrically coupling with the speaker.

The lighting device may include one or more of a LED light, a fluorescent light, a halogen light, and an incandescent light. The modular track feature may be configured to be securely mounted to a wall. The modular wall mounting system may further include one or more decor features configured to physically couple with the modular track feature.

According to another implementation, a modular wall mounting system may include a control module including a power module configured to be coupled to a line voltage source and to provide a power distribution output. The control module may also include a communication module configured to interact with an external computing device. The modular wall mounting system may also include a modular track feature including a plurality of power distribution rails configured to be coupled with the power module. At least a portion of the power distribution rails may be exposed for contact coupling with a power consumption device. The modular wall mounting system may also include a lighting device configured to physically couple with the modular track feature and electrically couple with at least a portion of the plurality of power distribution rails for powering the lighting device. The communication module may be configured to receive lighting control inputs from the external computing device. The control module may be configured to control the lighting device based upon the received lighting control inputs.

One or more of the following features may be included. The modular wall mounting system may further include a plurality of lighting devices configured to be coupled with the modular track feature. The control module may be configured to provide a first control associated with at least a first lighting device and a second control associated with at least a second lighting device.

According to yet another embodiment, a modular wall mounting system may include a control module including an audio module configured to receive a source audio input signal and to provide an audio output signal. The control module may be configured to interact with an external computing device to receive streaming audio from the external computing device. The modular wall mounting system may also include a modular track feature including one or more audio distribution conductors at least partially disposed within the modular track feature. The one or more audio distribution conductors may be configured to be coupled to the audio module. The modular wall mounting system may also include a speaker configured to physically couple with the modular track feature and electrically couple with the audio distribution conductors for receiving the audio output signal from the control module.

One or more of the following features may be included. The plurality of audio distribution conductors may include a wiring assembly at least partially disposed within the modular track feature. The plurality of audio distribution conductors may include a plurality of conductive rails having at least one exposed surface for electrically coupling with the speaker.

The details of one or more implementations are set forth in the accompanying drawings and the description below. Other features and advantages will become apparent from the description, the drawings, and the claims.

### BRIEF DESCRIPTION OF THE DRAWINGS

FIG. 1 schematically depicts an example embodiment of a control module that may be used in connection with a modular wall mounting system, according to some embodiments;

FIG. 2 schematically depicts an example embodiment of a modular track feature that may be used in connection with a modular wall mounting system, according to some embodiments;

FIG. 3 schematically depicts an example embodiment of a modular wall mounting system;

FIGS. 4A-4F diagrammatically depict various example embodiments of interacting features that may be implemented for mechanically coupling the modular track feature and one or more devices, consistent with some example embodiments of a modular wall mounting system; and

FIGS. 5A-5D depict various example aesthetic, stylistic, and configurational implementations of a modular wall mounting system according to several example embodiments.

FIGS. 6A-6C depict various example aesthetic, stylistic, and configurational implementations of a modular wall mounting system according to several example embodiments.

FIGS. 7A-7C depict various example aesthetic, stylistic, and configurational implementations of a modular wall mounting system according to several example embodiments.

FIG. 8 depicts an example aesthetic, stylistic, and configurational implementations of a modular wall mounting system according to several example embodiments.

FIG. 9 depict various example aesthetic, stylistic, and configurational implementations of a modular wall mounting system according to several example embodiments.

depict various example aesthetic, stylistic, and configurational implementations of a modular wall mounting system according to several example embodiments.

FIG. 10 depict various example aesthetic, stylistic, and configurational implementations of a modular wall mounting system according to several example embodiments.

FIG. 11 depict various example aesthetic, stylistic, and configurational implementations of a modular wall mounting system according to several example embodiments.

FIGS. 12A and 12B depict various example aesthetic, stylistic, and configurational implementations of a modular wall mounting system according to several example embodiments.

FIGS. 13A and 13B depict various example aesthetic, stylistic, and configurational implementations of a modular wall mounting system according to several example embodiments.

FIGS. 14A-14D depict various example aesthetic, stylistic, and configurational implementations of a modular wall mounting system according to several example embodiments.

FIGS. 15A-15C depict various example aesthetic, stylistic, and configurational implementations of a modular wall mounting system according to several example embodiments.

FIGS. 16A-16D depict various example aesthetic, stylistic, and configurational implementations of a modular wall mounting system according to several example embodiments.

FIG. 17 depicts various example aesthetic, stylistic, and configurational implementations of a modular wall mounting system according to several example embodiments.

FIG. 18 depicts various example aesthetic, stylistic, and configurational implementations of a modular wall mounting system according to several example embodiments.

FIGS. 19A and 19B depict various example aesthetic, stylistic, and configurational implementations of a modular wall mounting system according to several example embodiments.

FIG. 20 depicts various example aesthetic, stylistic, and configurational implementations of a modular wall mounting system according to several example embodiments.

FIG. 21 depicts various example aesthetic, stylistic, and configurational implementations of a modular wall mounting system according to several example embodiments.

FIG. 22 depicts various example aesthetic, stylistic, and configurational implementations of a modular wall mounting system according to several example embodiments.

FIG. 23 depicts an example aesthetic, stylistic, and configurational implementations of a modular wall mounting system according to several example embodiments.

FIGS. 24A-24C depict various example aesthetic, stylistic, and configurational implementations of a modular wall mounting system according to several example embodiments.

FIGS. 25A-25D depict various example aesthetic, stylistic, and configurational implementations of a modular wall mounting system according to several example embodiments.

FIG. 26 depicts various example aesthetic, stylistic, and configurational implementations of a modular wall mounting system according to several example embodiments.

### DETAILED DESCRIPTION OF EXAMPLE EMBODIMENTS

A modular wall mounting system consistent with the present disclosure may generally provide a mounting structure that may be attached to a wall. The mounting structure may include a modular track feature that may be configured, at least in part, for physically coupling to various decor features. Physically coupling decor features to the modular track feature, which is itself attached to a wall, may serve to effectively wall mount the various decor features. Examples of decor features that may be physically coupled, or mounted, to the modular track feature may include, but are not limited to, shelves, audio-visual components (e.g., tuners, CD players, televisions, etc.) and/or audio-visual component racks or supports, lighting features, decorative features, or the like. In addition to providing a mounting structure for one or more decor features (in addition and/or as an alternative to any innate decorative or aesthetic character provided by the modular track feature itself), the modular track feature may also provide a power distribution and/or audio-visual distribution network, while minimizing and/or eliminating visually apparent cords or wires. For example, in some embodiments the modular track feature may incorporate power distribution conductors that may provide electrical power to devices such as lighting features, charging docks or stations (e.g., which may couple to rechargeable electronics such as portable music players, mobile computing devices, smartphones, tablet computing devices, laptops, etc.), audio-visual components, and the like. In some embodiments, the power distribution conductors may be incorporated into and/or at least partially concealed within the modular track features so as to eliminate the visual prominence of electrical cords within a room. In addition/as an alternative to providing a power distribution network, in an example embodiment the module track feature may incorporate one or more audio (and/or audio-video) distribution conductors. The audio distribution conductors may, for example, be capable of providing an audio output signal for driving one or more speakers (and/or one or more audio-video consumption devices, such a television, a monitor, or the like).

In some embodiments, the modular wall mounting system may include a control module. The control module may, for example, provide a power source feeding the power distribution network. For example, the control module may be coupled with the electrical system of a building, such as a residential home, commercial building, or the like. For example, the control module may be hardwired into the electrical system of the building, or may plug into an electrical outlet included as part of the electrical system of the building. In some embodiments, the power distribution network may provide line voltage power, e.g., which may be generally of the same voltage as the electrical system of the building. In some embodiments, the power distribution network may provide a low voltage power, either alternating current or direct current. In such an embodiment, the control module may include a transformer and/or rectifier circuit for reducing the voltage of the provided power and/or for converting an alternating current electrical input to a direct current output for distribution via the power distribution network. In some embodiments, the control module may provide an audio output signal, e.g., which may be distributed to one or more speakers or audio/audio-visual consumption devices via the audio distribution network provided by the modular track feature. In some embodiments, the control module may include an amplifier, an equalizer, or other audio processing components that may receive an audio input signal from a suitable source (such as a tuner, a CD player, a DVD player, a digital music player, or the like). In some such embodiments, the control module may process the audio input signal (e.g., by amplifying the signal or the like), and may provide the processed audio signal as an audio output signal to the audio distribution network provided by the modular track feature. In some embodiments, the control module may receive an audio input signal from a suitable source and may provide the audio input signal to the audio distribution network provided by the modular track feature as an audio output signal without processing the audio input signal by the control module. Various additional and/or alternative features may be included.

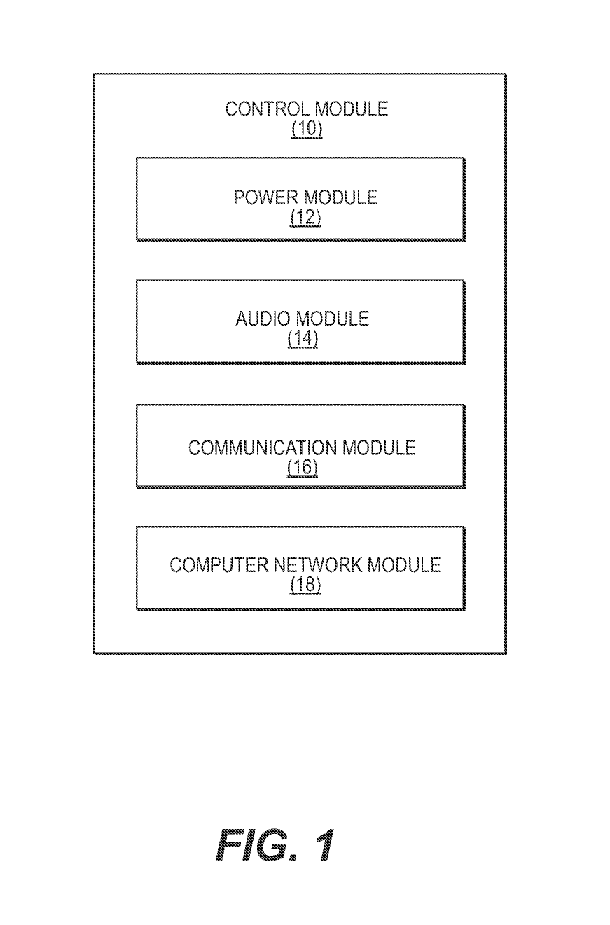

As generally described above, and referring also to FIG. 1, in an embodiment the modular wall mounting system may include control module 10. In general, control module 10 may include power module 12. Power module 12 may generally be configured to be coupled to a line voltage source and to provide a power distribution output. For example, power module 12 may be configured to be hardwired into a building electrical system, e.g., of a residential house, a commercial building or the like. In such an example, power module 12 may be connected to the building electrical system in a similar manner as other hardwired devices, such as electrical outlets, lighting fixtures, etc. In some embodiments, power module 12 may be coupled to the building electrical system by being plugged into a common receptacle. For example, control module 10 may include an electrical cord having a plug that can be plugged into the receptacle for coupling power module 12 with the line voltage source of the building electrical system. In such an embodiment, the electrical cord may allow control module 10 to be located away from the receptacle. In some embodiments, control module 10 may include an integrated plug extending from a rear of the housing. In such an embodiment, control module 10 may be plugged directly into the receptacle. In such an embodiment, the need for and/or visual presence of an electrical cord may be eliminated. In some such embodiments, control module 10 may be at least partially supported on a wall by the physical connection provided between the integrated plug and the receptacle.

According to various embodiments the power distribution output provided by power module 12 may include one or more of a line voltage output, a low voltage alternating current output, and low voltage direct current output. For example, a line voltage output may be provided having a similar voltage to that provided by the line voltage source, which may originate from the building electrical system. In some embodiments, power module 12 may include a step down transformer to provide a low voltage output, such as a 6 volt output, a 12 volt output, and/or a 24 volt output. It will be appreciated that while 6 volt, 12 volt, and 24 volt outputs may be utilized in connection with commonly available low voltage electrical devices, various additional and/or alternative voltages less than full line voltage may be utilized. Additionally, in some embodiments a provided low voltage power distribution output may include an alternating current output or a direct current output. It will be appreciated that the direct current output may be provided from an alternating current line voltage source through the use of rectifying circuits, or similar circuits. In some embodiments, power module 12 may provide a variety of power distribution outputs. For example, in an embodiment power module 12 may provide both a line voltage output and a 12 volt direct current low voltage output. In other embodiments, power module 12 may provide multiple low voltage outputs. For example, power module 12 may provide a 6 volt output and a 12 volt output. It will be appreciated that various output voltage combinations may be utilized.

The control module may also include audio module 14 configured to receive a source audio input signal and to provide an audio output signal. As used herein the audio input signal and the audio output signal are intended to include an audio signal, as well as an audio-video signal. In an embodiment, audio module 14 may receive an audio input signal from any suitable source, such as an amplifier, a tuner, a CD player, a DVD player, a digital music player (including a computing device capable of providing an audio output signal), as well as any other suitable audio signal source. In an embodiment, audio module 14 may be configured to process the audio input signal to provide a desired audio output signal. For example, audio module 14 may include a digital decoder capable of decoding a digital audio signal to provide one or more audio output signals. For example, the audio input signal may include a digital signal that may include multiple audio channels (e.g., left and right channels, bass channel, treble channel). Audio module 14 may be capable of decoding the digital audio input signal to provide a discrete analog audio output signal associated with each of the decoded channels. The discrete analog audio output signals associated with each of the channels of the audio input signal may, for example, each be capable of driving a separate speaker or speaker array, e.g., to reproduce the audio embodied by the digital signal. In some embodiments, audio module 14 may include an amplifier and/or an equalizer, e.g., which may be capable of processing an audio input signal, e.g., to provide an audio output signal having greater power and/or altered acoustic characteristics.

As generally described above, audio module 14 may provide a single audio output channel and/or may provide a plurality of audio output channels. Further, in some embodiments, audio module 14 may generally pass the audio input signal, without substantial alteration, to the audio output signal. In some such configurations, audio module 14 may generally include a pass-through device. In various embodiments, audio module 14 may provide audio output signals configured to be utilized by various audio devices. For example, the audio output signals may be configured for driving one or more speakers. Further, the audio output signals may be configured for being received by one or more additional audio components, such as an audio amplifier or the like. Accordingly, in various embodiments, the audio output signals may include an analog signal and/or may include a digital signal. While in some embodiments the audio output signals may include an electrical signal, e.g., which may be transmitted over a physical conductor, in some embodiments the audio output signals may include analog and/or digital wireless signals transmitted via WiFi, Bluetooth, and/or another suitable wireless transmission protocol or format.

While the foregoing description has discussed control module 10 as including various modules, such as power module 12 and audio module 14 (as well as various additional possible modules discussed below), it will be appreciated that the various modules may be combined into a single module and/or one or more of the modules may be separated into two or more discrete modules. In this regard, the identified modules may include one or more components solely and/or partially providing the described functionality. Additionally, while the various modules have been described (and may further be described below) as being included within the control module, it will be appreciated that one or more described modules may be physically separate from the control module. Further, in some embodiments, one or more of the described modules may be physically discrete from one or more of the other modules, but may be contained within a common housing. Various additional and/or alternative configurations will be understood.

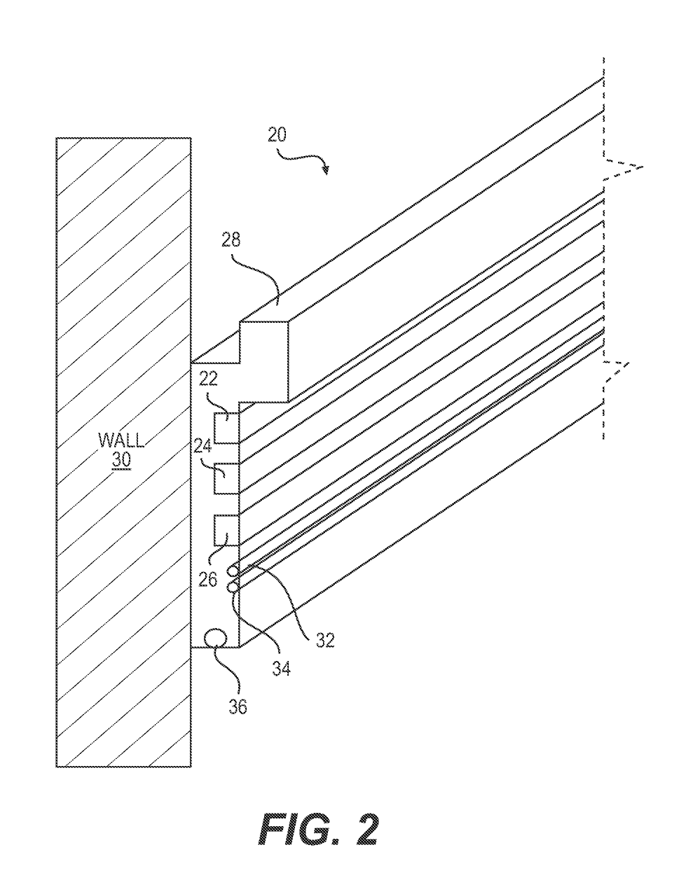

The modular wall mounting system may also include modular track feature 20, schematically depicted in FIG. 2. In general, modular track feature 20 may include a longitudinal member that is configured to be attached to a wall of a building, such as a residential house or a commercial building. The longitudinal member of modular track feature 20 may be attached to a wall using various suitable arrangements, such as an adhesive (e.g., double-sided adhesive tape, construction adhesive, or other suitable adhesive), mechanical fasteners (e.g., screws, nails, or the like), as well as various other suitable attachment arrangements. The attachment arrangement utilized may vary depending, for example, on a desired weight bearing capacity of modular track features, structural features of the wall (e.g., construction materials and design, loadbearing capacity, and the like) to which modular track feature 20 is attached, building codes, as well as installer preference. Modular track feature 20 may be formed from various suitable materials, including but not limited, aluminum, steel, plastic, fiber reinforced plastic, wood, manufactured wood products, as well as combinations thereof. It will be appreciated, in view of the following description, that modular track feature 20 may be formed from various additional and/or alternative materials.

The modular track feature (e.g., modular track feature 20) may include a plurality of power distribution rails (e.g., power distribution rails 22, 24, 26) configured to be coupled with power module 12. For example, power distribution rails 22, 24, 26 may be electrically and/or physically coupled with power module 12 of control module 10. In some embodiments, physical and/or electrical coupling between power distribution rails 22, 24, 26 of modular track feature 20 and power module 12 may include physical coupling between control module 10 and modular track feature. For example, control module 10 may be attached to modular track feature 20 via interacting mechanical features included on control module 10 and modular track feature 20. In the illustrated example of FIG. 2, modular track feature 20 may generally define a groove between a upward flange 28 and the wall (e.g., wall 30) to which modular track feature 20 is attached. In an embodiment, control module 10 may include a cooperating downward flange that may engage the groove, and at least a portion of control module 10 may be profiled to fit over modular track feature 20. In an embodiment, one or more electrical contacts associated with power module 10 may electrically couple with one or more of power distribution rails 22, 24, 26. It will be appreciated that other interacting features associated with control module 10 and modular track feature 20 may be utilized for physically coupling control module 10 and modular track feature 20. Further, in addition, or as an alternative to, interacting mechanical features various other attachment mechanisms may be used, such as adhesives, screws, snap fit connectors, and the like. Additionally, in some embodiments, control module 10 may not be physically coupled with modular track feature 20. In such an embodiment, one or more conductors (such as individual wires or a wiring harness) may be utilized to electrically couple one or more of power distribution rails 22, 24, 26 with power module 12.

In an example embodiment, at least a portion of power distribution rails 22, 24, 26 may be exposed for contact coupling with a power consumption device. For example, as shown in FIG. 2 power distribution rails may include conductive elements, with at least a portion of each element being exposed and/or accessible from an exterior of module track feature 20. Consistent with such an arrangement, a power consuming device may be electrically coupled with one or more of power distribution rails 22, 24, 26 via interacting electrical contacts, for example, when the power consuming device (and/or an electrical connector associated with the power consuming device) is connected to modular track feature 20, e.g., using interacting mechanical features associated with the power consuming device and modular track feature 20 (for example, in a generally similar manner as described above with respect to control module 10). It will be appreciate that various additional and/or alternative electrical coupling arrangements may be utilized. Further, it will be appreciated that in an embodiment in which modular track feature 20 may include a conductive material (such as aluminum, steel, or the like) an insulating material may be provided between power distribution rails 22, 24, 26 and modular track feature 20, e.g., to electrically isolate power distribution rails 22, 24, 26 and modular track feature 20.

While power distribution rails 22, 24, 26 are shown as being exposed on an outward face of modular track feature 20, in some embodiments one or more of power distribution rails may be at least partially recessed and/or disposed within a groove and/or behind flange 28 or a similar feature associated with modular track feature 20. Consistent with such a configuration, the chance or occurrence of unintentional contact between power distribution rails 22, 24, 26 and a user or a foreign object may be reduced or eliminated. As such, the risk of injury or damage may be reduced, particularly in applications in which one or more of power distribution rails 22, 24, 26 may operate at a relatively higher voltage. In some embodiments, power module 12 may include one or more sensors that may, for example, detect a short circuit condition, a ground fault condition, and/or an electrical arching condition associated with one or more of power distribution rails 22, 24, 26 and/or a power consuming device electrically coupled with one or more of power distribution rails 22, 24, 26. In response to detecting such a condition, power control module 12 may discontinue supplying power to power distribution rails 22, 24, 26, e.g., in the manner of a circuit breaker or other safety shutoff.

The plurality of power distribution rails may include power distribution rails providing different voltages. For example, in the illustrated embodiment, modular track feature 20 may include three power distribution rails (i.e., power distribution rails 22, 24, 26). In an embodiment, power distribution rail 22 may be electrically coupled with a 12 volt power source and power distribution rail 24 may be associated with a 24 volt power source. Further, power distribution rail 26 may include a ground rail, e.g., which may serve as a ground for both the 12 volt power source provided via power distribution rail 22 and for the 24 volt power source provided via power distribution rail 24. It will be appreciated that while modular track feature is shown including two relatively low voltage power distribution rails, a greater or fewer number of power distribution rails and/or voltage may be utilized. For example, one or more power distribution rails for use with a line voltage power source may be utilized. Further, which power distribution rails 22 and 24 are shown utilizing a common ground (i.e., power distribution rail 26), in other embodiments, separate ground rails may be utilized.

Modular track feature 20 may also include one or more audio distribution conductors (e.g., audio distribution conductors 32, 34) configured to be coupled with the audio module 14. As generally described above, audio module 14 may provide one or more audio output signal that may be utilized by an audio component, such as a speaker, a subwoofer, an amplifier, a television, or the like. Audio distribution conductors 32, 34 may provide the connection between audio module 14 and the one or more audio components utilizing the audio output signal from audio module 14. As shown, audio distribution conductors 32, 34 may include a wiring assembly that may be at least partially disposed within modular track feature 20. As shown in the illustrated embodiment, audio distribution conductors 32, 34 may be disposed in grooves or channels on the outer face of modular track feature 20 (e.g., with at least a portion of audio distribution conductors 32, 34, exposed along the outer face of modular track feature 20). In some embodiments, audio distribution conductors may be disposed within one or more channels, grooves, or passages within modular track feature 20 and/or within a rear face of modular track feature 20 (e.g., which may be adjacent wall 30). In such an arrangement, audio distribution conductors 32, 34 may not be visible from the front face of modular track feature 20. Further, in some such arrangements, audio distribution conductors 32, 34 may not be generally accessible from the front face of modular track feature 20. Accordingly, one or more openings may be formed in modular track feature 20 for accessing audio distribution conductors 32, 34 (e.g., for connecting audio distribution conductors with a device utilizing the audio output signal). The one or more openings may be pre-formed in modular track feature 20, for example, at intervals along the length of modular track feature 20. In an embodiment, pre-formed openings in modular track feature 20 may include knock-out features that may be removed, as desired, to allow access to audio distribution conductors 32, 34 for coupling with one or more devices utilizing the audio output signal. In some embodiments, openings may be formed in modular track feature 20, for example, by cutting or drilling, to provide access to audio distribution conductors on an as-needed basis (e.g., to allow coupling with one or more devices utilizing the audio output signal).

In an embodiment, the plurality of audio distribution conductors (e.g., audio distribution conductors 32, 34) may include a plurality of conductive rails having at least one exposed surface for electrically coupling with the speaker, or other device utilizing the audio output signal. For example, in a generally similar manner as described with respect to power distribution rails 22, 24, 26, audio distribution conductors 32, 34 may include conductive rails that may be at least partially exposed and/or accessible from an exposed exterior surface of modular track feature 20. In such an embodiment, a device utilizing the audio output signal (and/or a connector associated with a device utilizing the audio output signal) may physically connect with modular track feature 20, and may include one or more contacts that may electrically couple with at least partially exposed audio distribution conductors 32, 34. The contacts that may electrically couple with at least partially exposed audio distribution conductors 32, 34 may provide the audio output signal to the device that may utilize the audio output signal. Physical connection between modular track feature 20 and the device utilizing the audio output signal (and/or a connector associated with the device utilizing the audio output signal) may use interacting mechanical features (e.g., as described above), separate fasteners (such as screw, snap fit fasteners, or the like), adhesives (e.g., double-sided tape, construction adhesive, etc.), or other suitable mechanisms to maintain the device utilizing the audio output signal (and/or a connector of the device utilizing the audio output signal) in position relative to modular track feature 20 so as to maintain the coupling with at least partially exposed audio distribution conductors 32, 34.

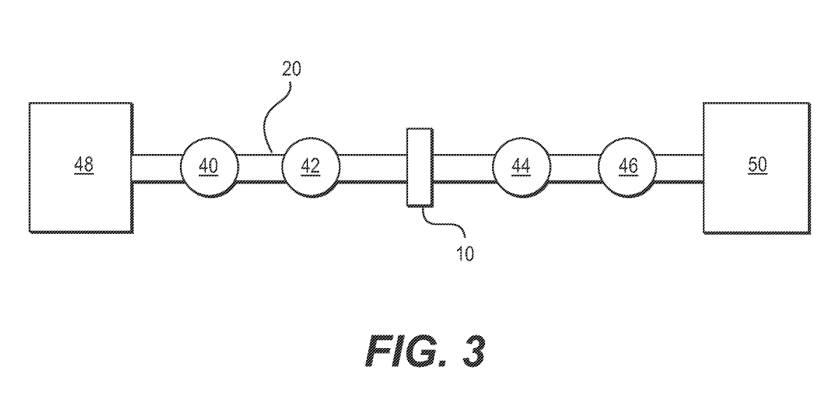

The modular wall mounting system may also include a lighting device configured to physically couple with the modular track feature, and electrically couple with at least a portion of the plurality of power distribution rails for powering the lighting device. For example, and referring also to FIG. 3, an example modular wall mounting system is schematically shown including control module 10 mounted to modular track feature 20. Further, one or more lighting devices (e.g., lighting devices 40, 42, 44, 46) may be physically coupled to modular track feature 20. Lighting devices 40, 42, 44, 46 may also be electrically coupled with one or more of the power distribution rails (e.g., power distribution rails 22, 24, 26). It will be appreciated that, in an embodiment utilizing a plurality of power distribution rails providing different voltages, lighting devices 40, 42, 44, 46 may be electrically coupled to the same power distribution rail (or set of rails providing a completed circuit), and may operate utilizing the same voltage. In other embodiments, one or more of lighting devices 40, 42, 44, 46 may be electrically coupled to a different power distribution rail (or set of rails) from at least another of lighting devices 40, 42, 44, 46, and may utilize a different voltage.

A wide variety of lighting device types and configurations may be used in connection with the modular wall mounting system. For example, the lighting device may include one or more of a LED light, a fluorescent light, a halogen light, and an incandescent light. Additionally, the lighting devices may be configured as one or more of wall sconces, drop lights, indirect lighting, task lighting fixtures, hidden lights (e.g., which may be at least partially obscured behind modular track feature 20 and/or another features associated with and/or attached to modular track feature 20). Various additional and/or alternative lighting device types and configurations may be utilized.

In some embodiments, each of lighting devices 40, 42, 44, 46 may include its own switch, thereby allowing each lighting device 40, 42, 44, 46 to be separately controlled. For example, the switch associated with each lighting device 40, 42, 44, 46 may include an on/off switch, a dimmer, or other suitable lighting control. In some embodiments, lighting devices 40, 42, 44, 46 may be controlled by control module 10 (in addition to, and/or as an alternative to, including their own switches). For example, control module 10 may switch one or more of power distribution rails 22, 24, 26 on or off (e.g., thereby switching lighting devices powered by the power distribution rail on or off). In addition/as an alternative to switching one or more of power distribution rails 22, 24, 26 on or off, control module 10 may vary the output of one or more of power distribution rails 22, 24, 26, e.g., to effectuate dimming of lighting devices associated with the power distribution rails. Varying the output of one or more of power distribution rails 22, 24, 26 may include, for example, varying a voltage provided via the power distribution rail, varying a duty cycle of the power provided via the power distribution rail (e.g., via a pulse width modulation control, or other suitable duty cycle control), and/or otherwise varying the output of one or more of power distribution rails. In an embodiment in which modular track feature 20 may include a plurality of power distribution rails, the individual power distribution rails may be individually controllable. In such an embodiment, lighting devices associated with individual ones, or sets, of power distribution rails may be separately controllable from lighting devices associated with other individual, or sets, of power distribution rails. As such, different lighting devices 40, 42, 44, 46 may be separately turned on or off and/or may be set to different relative lighting intensities (e.g., relative to the maximum available lighting intensity of each lighting device). Accordingly, control module 10 may provide a first control associated with at least a first lighting device and a second control associated with at least a second lighting device, to thereby separately control the first lighting device and the second lighting device.

In some embodiments, one or more of lighting devices 40, 42, 44, 46 may include a remotely controllable lighting control device, e.g., for turning the lighting device on or off and/or for dimming the lighting device. The remotely controllable lighting control device may include a wired lighting control device. For example, modular track feature 20 may include a lighting control conductor (and/or set of lighting control conductors) that may be coupled with one or more of lighting devices 40, 42, 44, 46 and may provide a control signal (e.g., from control device 10 via the lighting control conductor) to one or more of lighting control devices associated with lighting devices 40, 42, 44, 46. In some embodiments, a separate control conductor may be provided for each remotely controllable lighting device. In some embodiments, multiple lighting devices may utilize the same control conductor, and may receive lighting control signals coded for individual lighting devices 40, 42, 44, 46. In addition/as an alternative to a wired control signal, one or more of lighting devices 40, 42, 44, 46 may include a wireless remotely controllable lighting control device. A remotely controllable lighting control device may receive a wireless control signal from control module 10 and/or from another control source (e.g., such as a handheld remote control or the like). The wireless control signal may include an optical control signal (e.g., infrared control signal), a radio frequency control signal (e.g., WiFi control signal, Bluetooth control signal, and/or other radio frequency control signal), or the like. Each wireless remotely controllable lighting control device may control one or more associated lighting devices based upon, at least in part, a received wireless control signal.

In some embodiments, control module 10 may include communication module 16, which may be configured to interact with an external computing device. For example, control module 10 may be configured to receive lighting control inputs from the external computing device (e.g., via communication module). For example, control module 10 may be configured to receive control inputs from an external computing device, e.g., directly (via a wired or wireless connection—such as an Ethernet connection, a WiFi connection, a Bluetooth connection, or other suitable connection). In some embodiments, control module 10 may be coupled to a local area network and/or may be Internet accessible. As such, control module 10 may interact with an external computing device to receive lighting control inputs, e.g., for controlling the operation (e.g., on, off, dimmer condition, etc.) of one or more of lighting devices 40, 42, 44, 46. Examples of external computing device may include, but are not limited to, a personal computer, a smartphone, a laptop computer, a tablet computer, a gaming console, a smart TV, or other computing device. Control module 10 may be configured to control the lighting device based upon the received lighting control inputs.

With continued reference to FIG. 3, the modular wall mounting system of the present disclosure may further include a speaker (e.g., speakers 48, 50). Speakers 48, 50 may be configured to physically couple with modular track feature 20 and electrically couple with audio distribution conductors 32, 34 for receiving the audio output signal from the control module. Speakers 48, 50 may include any variety of speaker, such as convention speaker, a flat panel speaker, a speaker cluster (e.g., including multiple voicing elements optimized for different dynamic ranges), subwoofers (e.g., which may include powered subwoofers that may additionally electrically couple with one or more of power distribution rails 22, 24, 26), or the like. As generally described above, and also further described below, speakers 48, 50 (as well as other features such as lighting devices 40, 42, 44, 46, and control module 10) may be configured to physically couple with modular track feature 20 via interacting mechanical features that may retain speakers 48, 50 relative to modular track feature 20 in one or more planes. Additionally/alternatively, various mechanical fasteners (e.g., screws, snap fit connectors, etc.), adhesives (e.g., double-sided tape, construction adhesive, or the like), or other attachment arrangement may be utilized for physically coupling speakers 48, 50 relative to modular track feature 20.

Speakers 48, 50 may electrically couple with audio distribution conductors 32, 34 using conventional electrical connectors, such as RCA plugs, phono plugs, screw-down posts, etc. In some embodiments, audio distribution conductors 32, 34, may include conductive rails that may be electrically coupled with via surface contacts associated with speakers 48, 50 and/or connectors associated with speakers 48, 50. In some embodiments, physically coupling speakers 48, 50 with modular track feature 20 may generally align contacts associated with speakers 48, 50 relative to conductive rail audio distribution conductors 32, 34. In some such embodiments, physically coupling speakers 48, 50 with modular track feature 20 may act to effectuate electrically coupling speakers 48, 50 with audio distribution conductors 32, 34. In some embodiments, speakers 48, 50 may additionally/alternatively receive an audio signal via a wireless transmission, such as in the form of a WiFi or Bluetooth transmission. In some such embodiments, speakers 48, 50 may receive the wireless transmission, decode the received transmission, and generate an audio output based upon the received transmission (e.g., via an integrated receiver, decoder, and amplifier). In some such embodiments, rather the electrically coupling with audio distribution conductors, speakers 48, 50 may electrically couple with one or more of power distribution rails 22, 24, 26 (e.g., for powering one or more of the integrated receiver, decoder, and amplifier). Various additional/alternative configurations may also be implemented.

As described above, in some embodiments control module 10 may be coupled to a computing network. Accordingly, control module 10 may interact with the external computing device via a computing network, such as a local area network, the Internet, or another computing network. In some embodiments, control module 10 may be visible to other devices on the same network, e.g., to enable interaction between control module 10 and the other devices on the network. As described above, in some implementations it may be possible for a user to remotely control one or more lighting devices associated with the modular wall mounting system via the computing network. Further, in some embodiments, control module 10 (e.g., via communication module 16) may be capable of receiving streaming audio data from the external computing device. The streaming audio data may, for example, be passed to audio module 14 as an audio input signal. Audio module 14 may provide an audio output signal based upon, at least in part, the streaming audio data received via the communication module 16. As generally described above, the audio output signal may drive one or more speakers and/or may be utilized by another audio device coupled with the modular wall mounting system.

As generally discussed above, control module 10 may be capable of interacting with an external computer, e.g., for receiving lighting control signals and/or streaming audio or video from the external computer. In some such embodiments, control module 10 may be coupled with a computing network (e.g., a local area network, the Internet, or another computing network). As also discussed, in some embodiments, control module 10 may be visible to other devices on a given computing network, such as a home or office local area network. Further, in some embodiments control module may include a computing network module 18. In some embodiments, computing network module 18 include a wireless access point, a router, a switch, a USB hub, a wireless extender, or other computer networking device. As such, computing network module 18 may facilitate data communication and/or connectively relative to one or more computing networks or systems. In some embodiments, computing network module 18 may be configured to couple with one or more data distribution lines (e.g., data distribution line 36) included within modular track feature 20. In an embodiment, data distribution line 36 may be capable of coupling with one or more remote computing devices. For example, in addition to any wireless connectivity that may be provided by computing network module 18, data distribution line may provide a wired connection, e.g., to thereby allow additional remote computing devices, peripherals, accessories, or the like, to the accessible via computing network module 18 and/or one or more data networks associated with computing network module 18. Data distribution line may include, for example, an Ethernet connection, a USB connection, a video connection, other data connection.

As generally described above, various devices, (e.g., control module 10, lighting devices 40, 42, 44, 46, and speakers 48, 50, etc.) may be physically coupled with modular track feature 20. In some implementations, modular track feature 20 and the devices configured to be physically coupled with modular track feature 20 may include interacting mechanical features. The interacting mechanical features may, for example, align or locate the devices relative to modular track feature 20 in at least one plane. In some embodiments, the interacting mechanical features may be configured to align or locate the devices relative to modular track feature 20 in more than one plane. Further, as described above, in addition/as an alternative to any interacting features, additional securement or attachment features may be utilized for physically coupling the devices relative to modular track feature 20. Examples of such securement or attachment features may include, but are not limited to, mechanical fasteners (e.g., screws, nails, bolts, snap-fit fasteners, etc.), adhesives (e.g., double-sided tape, construction adhesive, contact cement, and the like), magnetic attachment features, as well as various other attachment mechanisms.

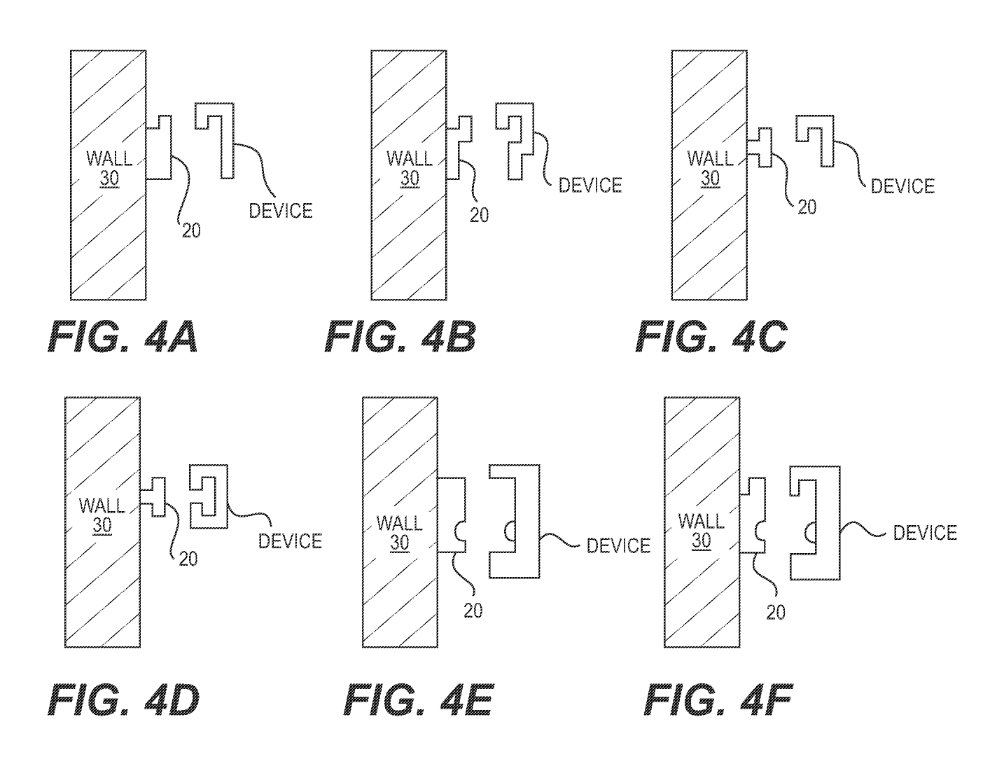

Referring to FIGS. 4a-4f, various example configurations of interacting features which may be used in connection with modular track feature 20 and devices to be physically coupled with modular track feature 20 are shown. According to some of the depicted embodiments, modular track feature and/or the device may include at least partially overlapping and/or interlocking features, e.g., that may aid in locating, aligning, and/or securing the device relative to modular track feature 20. As discussed above, additional securement or attachment mechanisms may be utilized, e.g., to further physically coupled the device and modular track feature 20. While various example embodiments of interacting features have been shown, it will be appreciated that various additional and/or alternative configurations may similarly be utilized.

As generally described above, modular track feature 20 may include a longitudinal member that may be secured to a wall, e.g., for further mounting various devices or features. In some embodiments, modular track feature 20 may be provided having different lengths, e.g., to suit a given application (e.g., a given size wall or desired wall mounting arrangement). In some situations, modular track feature 20 may be cut to a desired length. Further, in some embodiments, modular track feature 20 may include a plurality of modular track sections. Each of the modular track sections may be generally configured as described above with respect to modular track feature 20, generally. Each modular track section may be physically and electrically coupleable to one or more adjacent modular track sections. For example, modular track feature 20 may include a plurality of modular track sections that may be joined together to provide modular track feature, e.g., having a greater length than the individual modular track sections. Further, the individual modular track sections may be coupled in a linear array and/or in an angled orientation relative to one or more adjacent modular track sections. For example a first modular track section may be attached to a wall having a generally horizontal alignment. A second, adjacent, modular track section may be oriented at an angle to the first modular track section, or even having a vertical alignment. Additionally, modular track sections may be connected to extend around a corner (e.g., an inside corner or an outside corner) defined by the wall to which modular track feature 20 is attached.

Each of the modular track sections may be physically and electrically coupled relative to one or more adjacent modular track sections. In an embodiment, adjacent modular track sections may be physically coupled relative to one another by the individually secured to the wall in relative close proximity to one another. In some embodiments, adjacent modular track sections may include cooperating mechanical features, such as cooperating protrusions and recesses, or other mechanical features. The cooperating mechanical features may aid in aligning the adjacent modular track sections relative to one another. In some embodiments, the cooperating mechanical features (alone and/or in combination with mechanical fasteners, adhesives, magnets, etc.) may resist separation of the adjacent modular track section once they have been coupled to one another.

Adjacent modular track sections may be electrically coupled to one another, e.g., to provide electrically continuous power distribution rails, audio distribution conductors, data lines, and the like. Each electrical connection may utilize various electrical connectors, for example cooperating plugs and sockets, push-on connector features, at least partially overlapping conductors, screw-on connections, as well as any other suitable connectors. It will be appreciate that different connectors may be utilized depending, for example, and the relative magnitude of the voltage being transmitted (e.g., with respect to the power distribution rails) , the required signal fidelity (e.g., with respect to the audio distribution conductors and the data line), as well as various other design and quality considerations.

As described above, modular track feature 20 (e.g., including any constituent modular track sections) may be configured to be securely mounted to a wall. Various suitable mounting arrangements may be utilized. For example, modular track feature 20 may include holes or slots to facilitate screwing or nailing to the wall and/or underlying structural members. Double-sided tape, construction adhesive, or the like may also be utilized for securing modular track feature 20 to a wall. Various other attachment arrangements may similarly be utilized.

The modular track feature may include a plurality of aesthetic trim components. The aesthetic trim components may provide the modular track feature with various aesthetic appearances and styles. In some embodiments, the aesthetic trim components may be removably coupleable to an exterior surface of the modular track feature. In such a manner, the aesthetic appearance, or style, of the modular wall mounting system may be customized for different applications or tastes. The aesthetic trim components may be removably coupleable to the modular track feature using, for example, magnetic attachment features, adhesives, mechanical fasteners, snap-fit features, or other suitable attachment features.

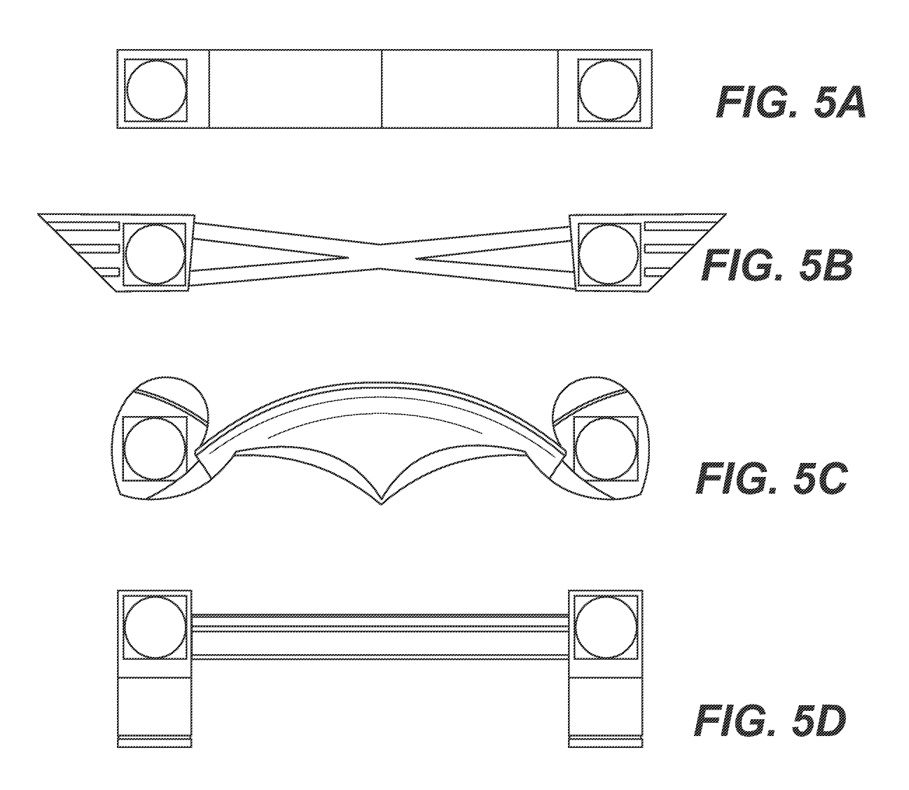

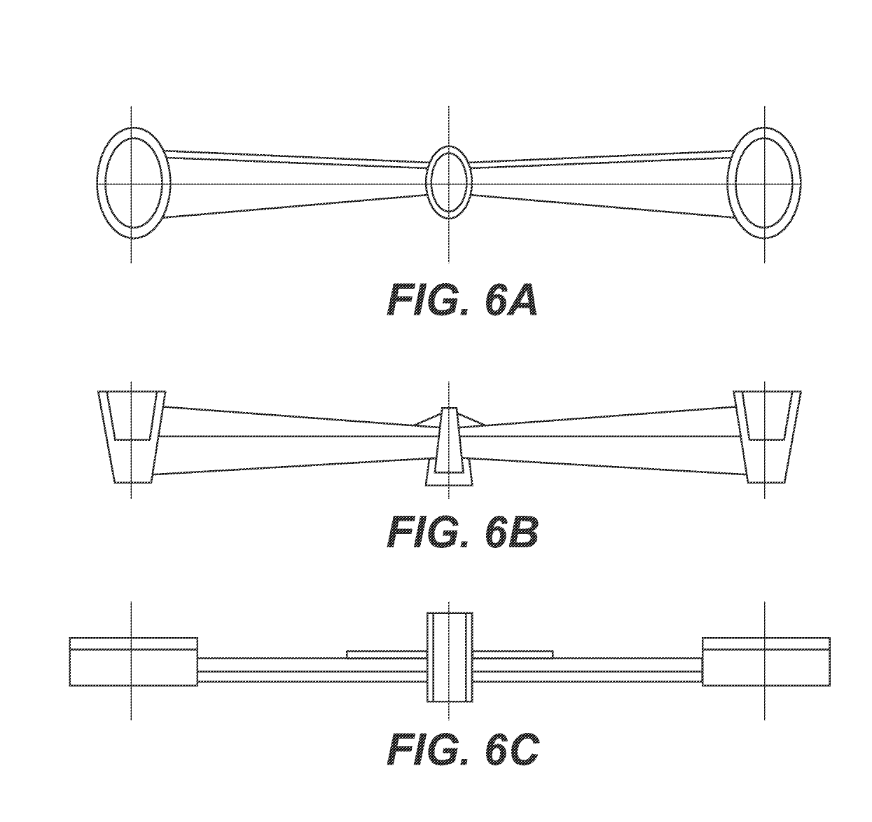

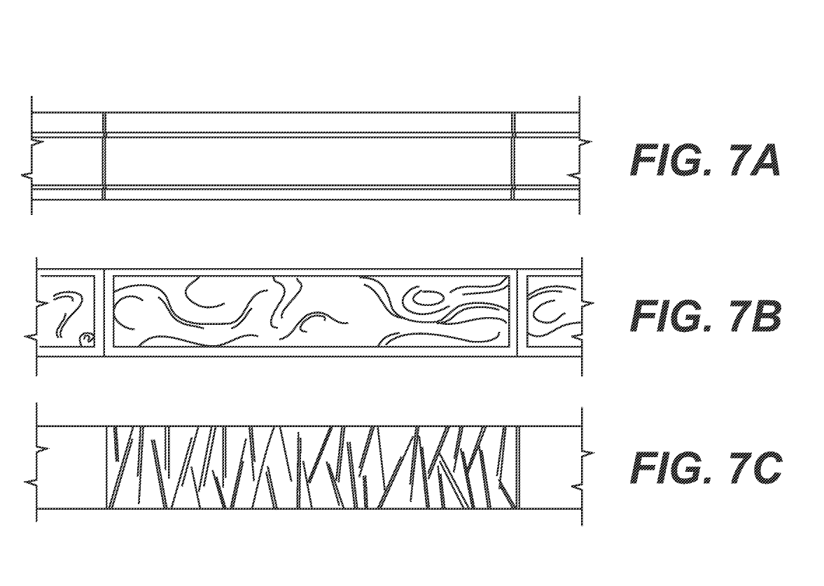

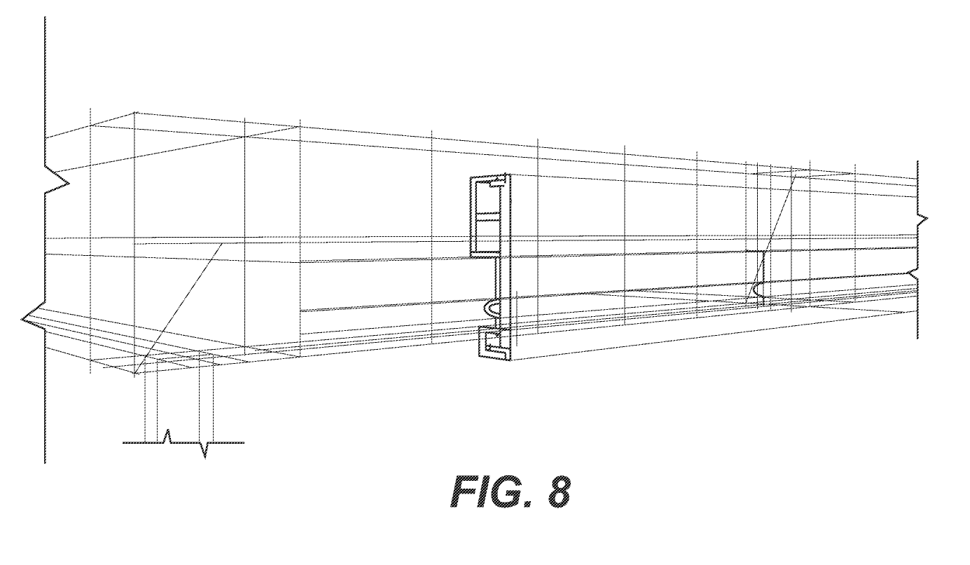

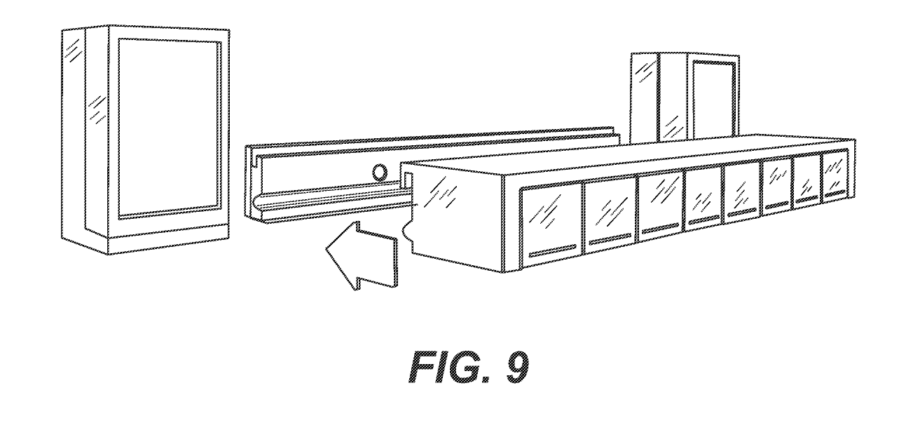

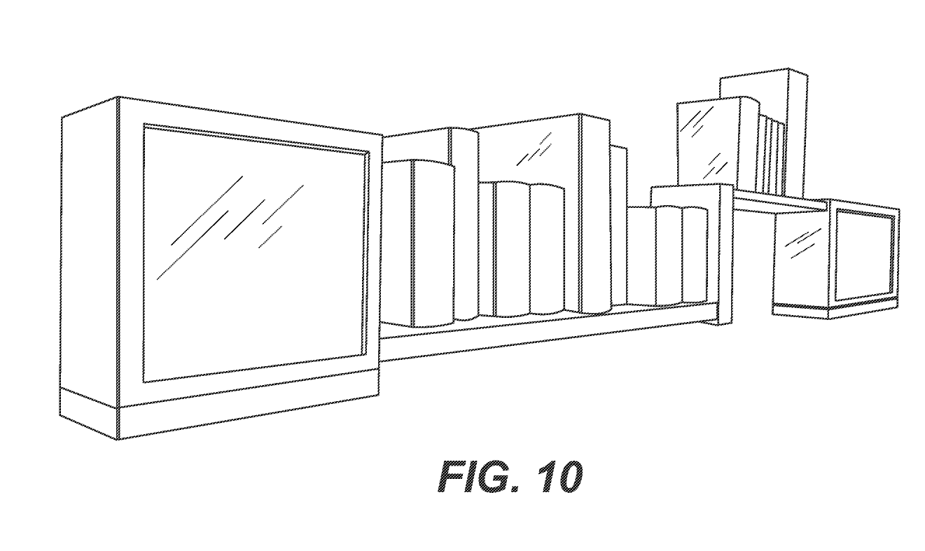

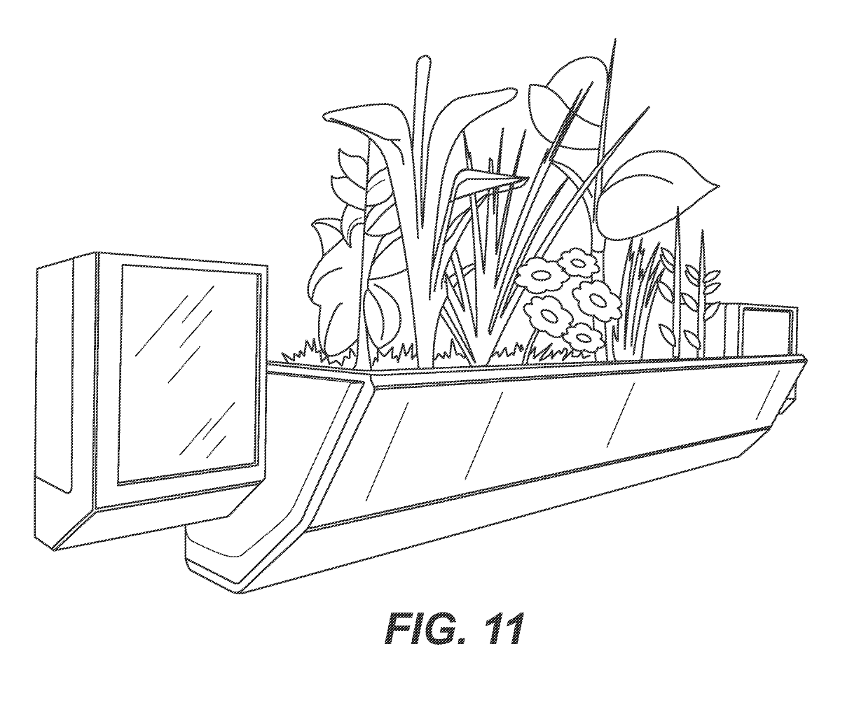

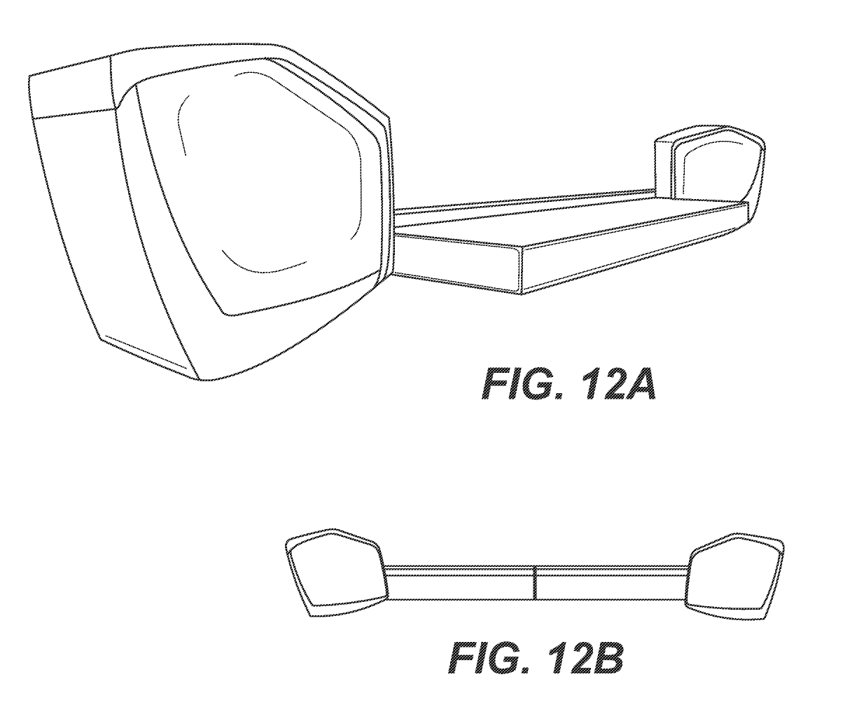

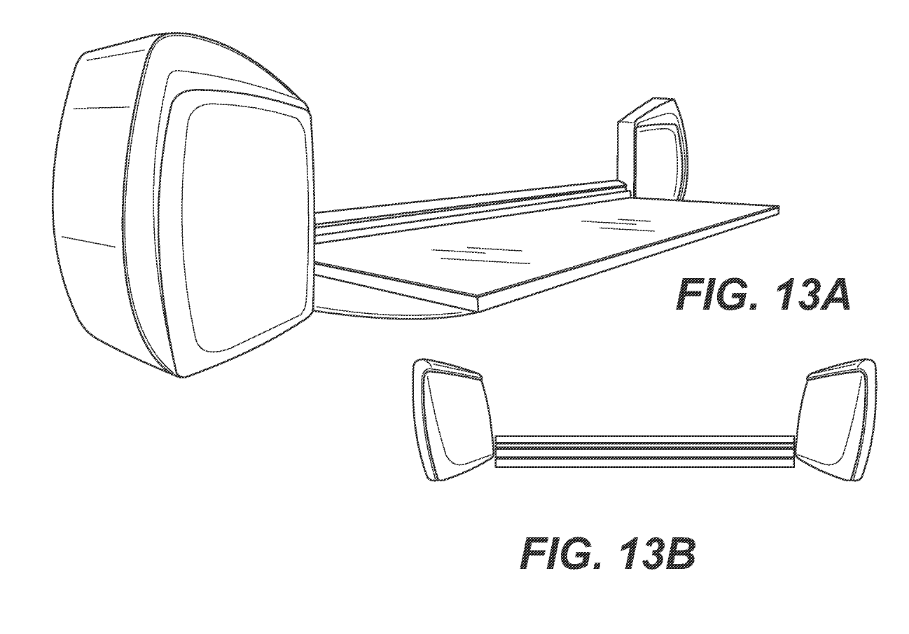

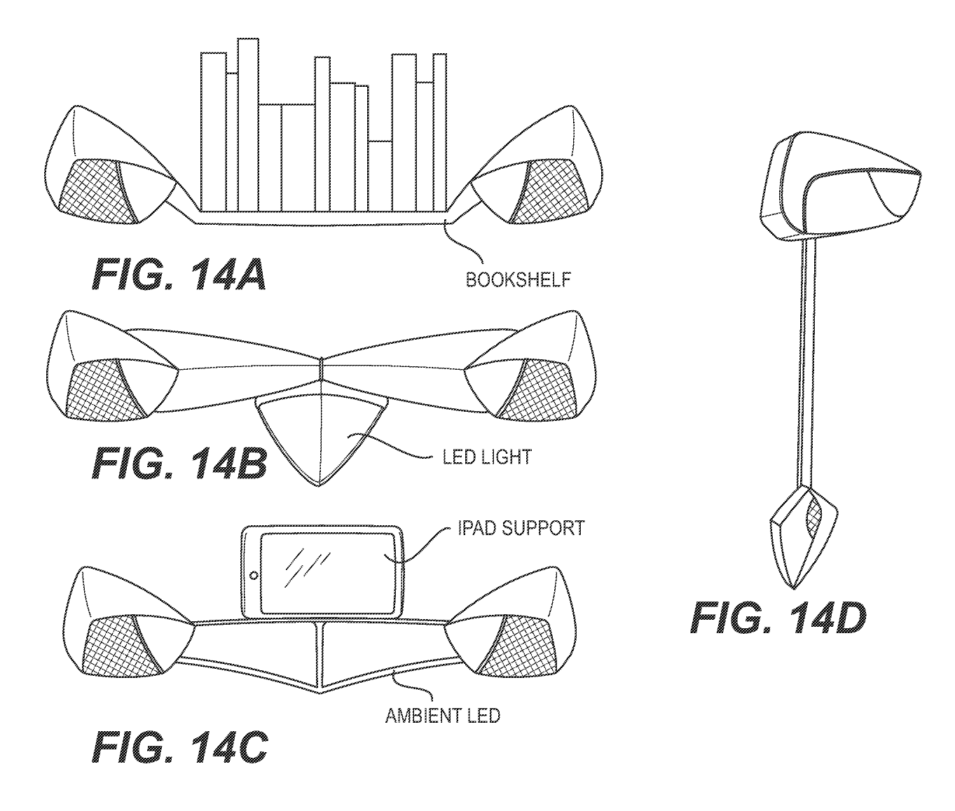

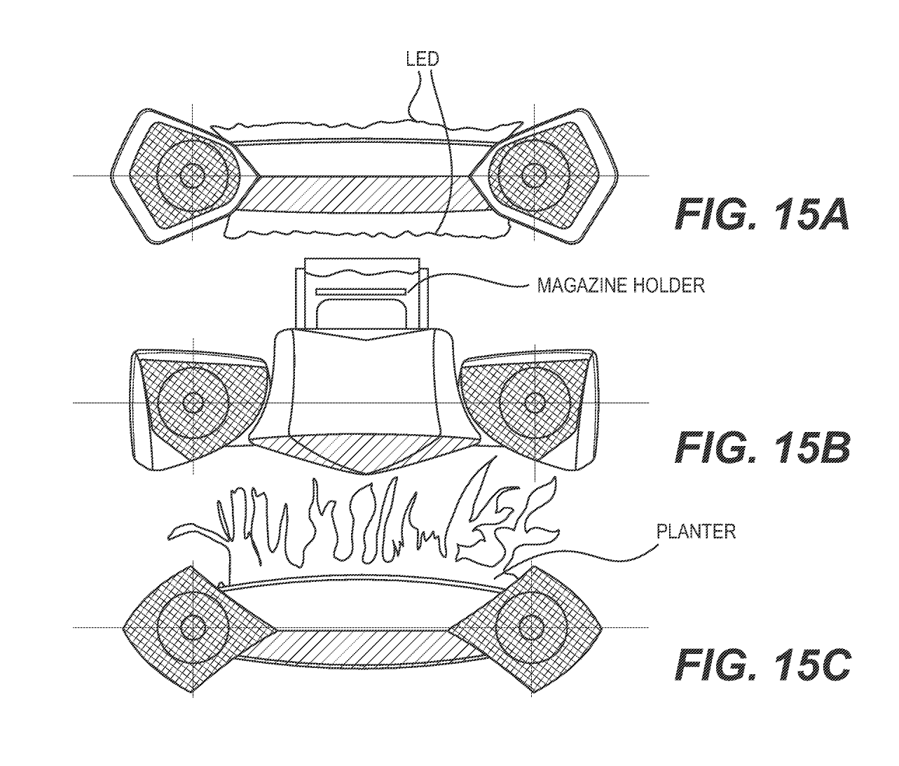

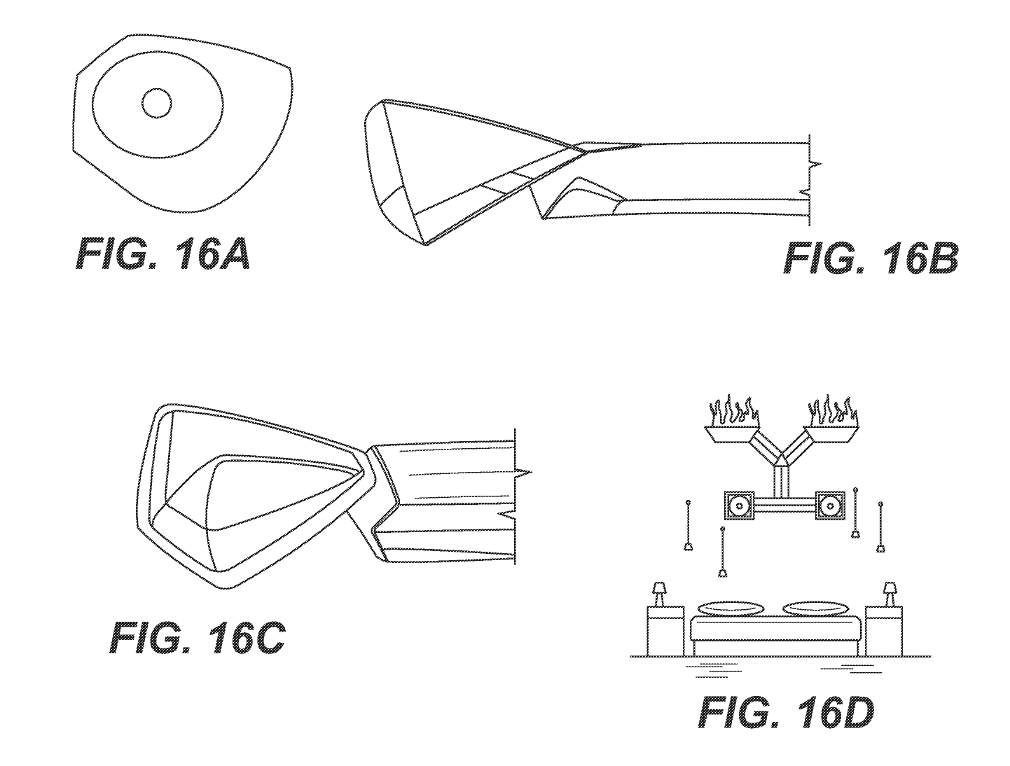

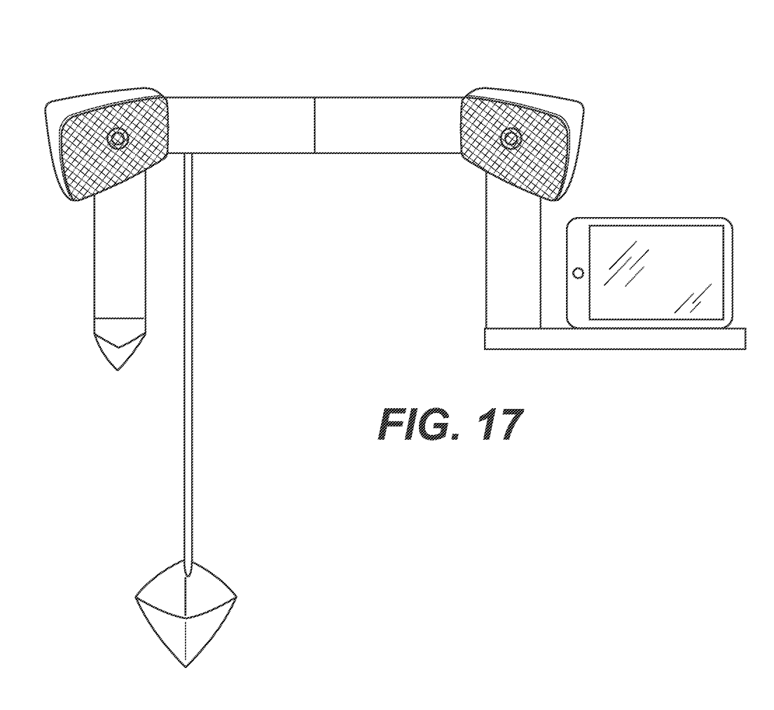

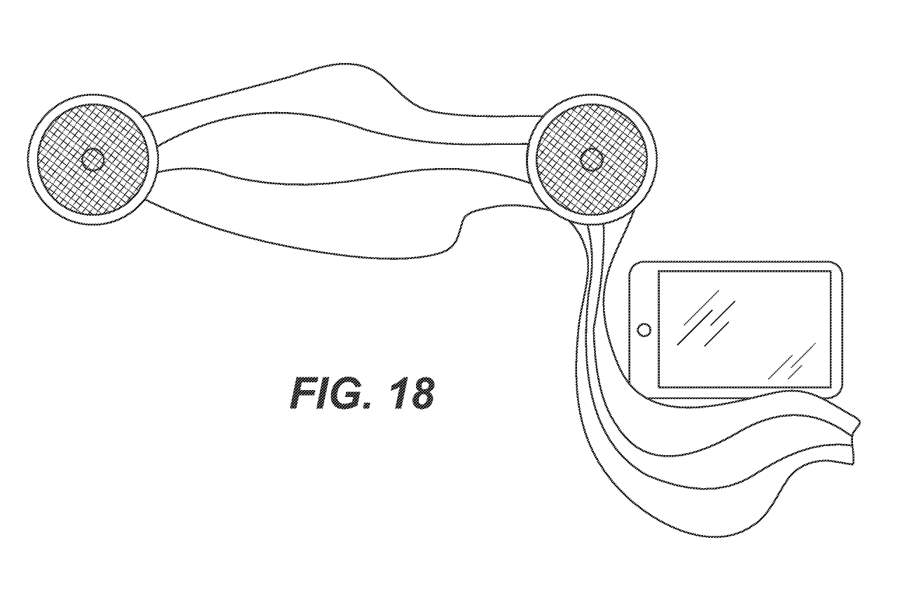

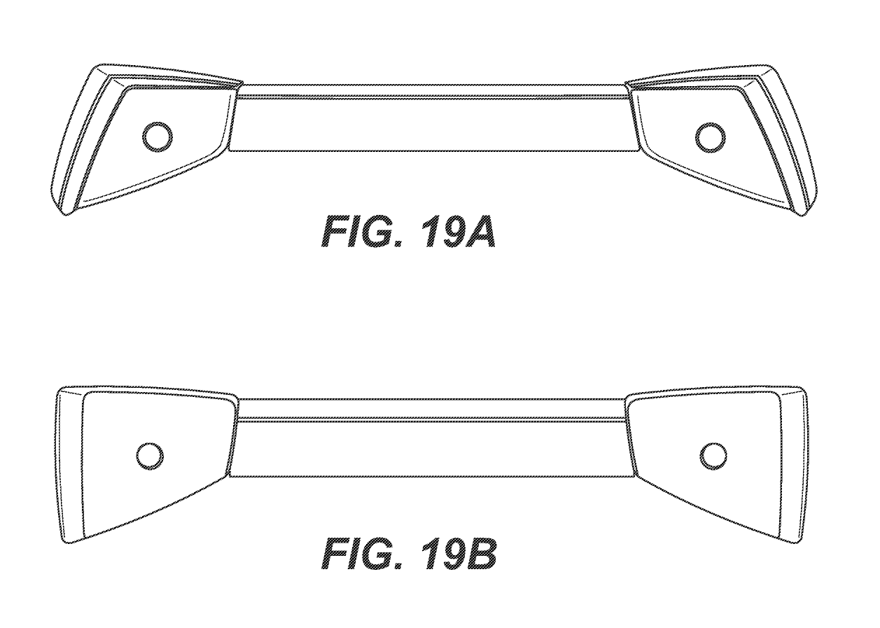

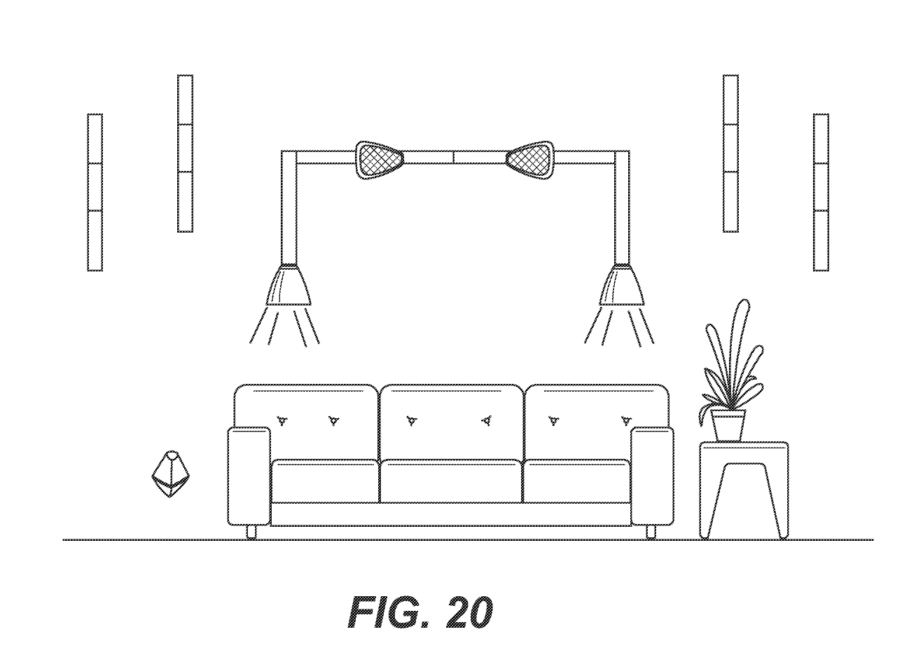

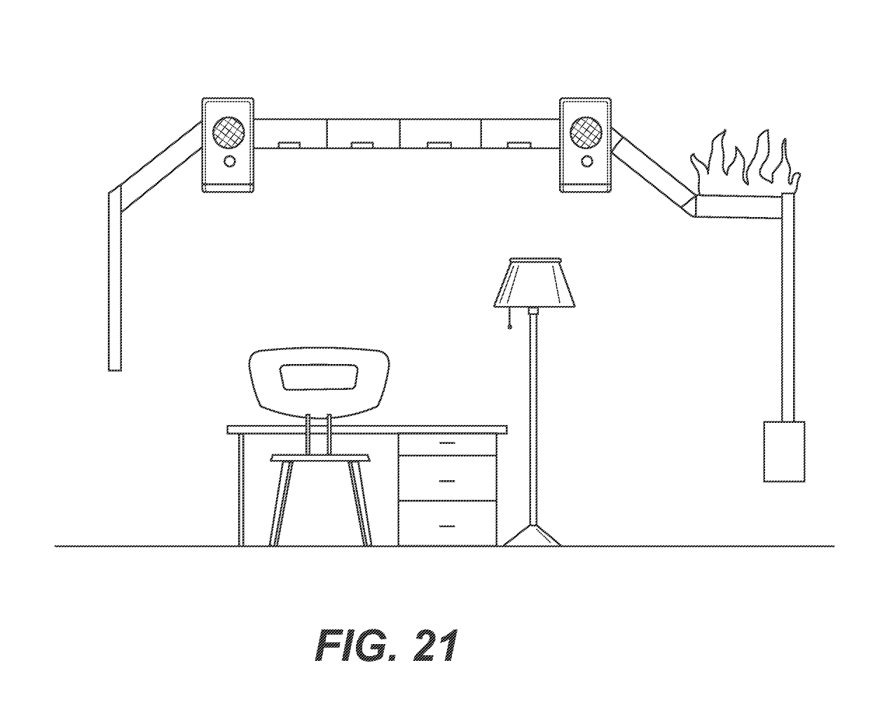

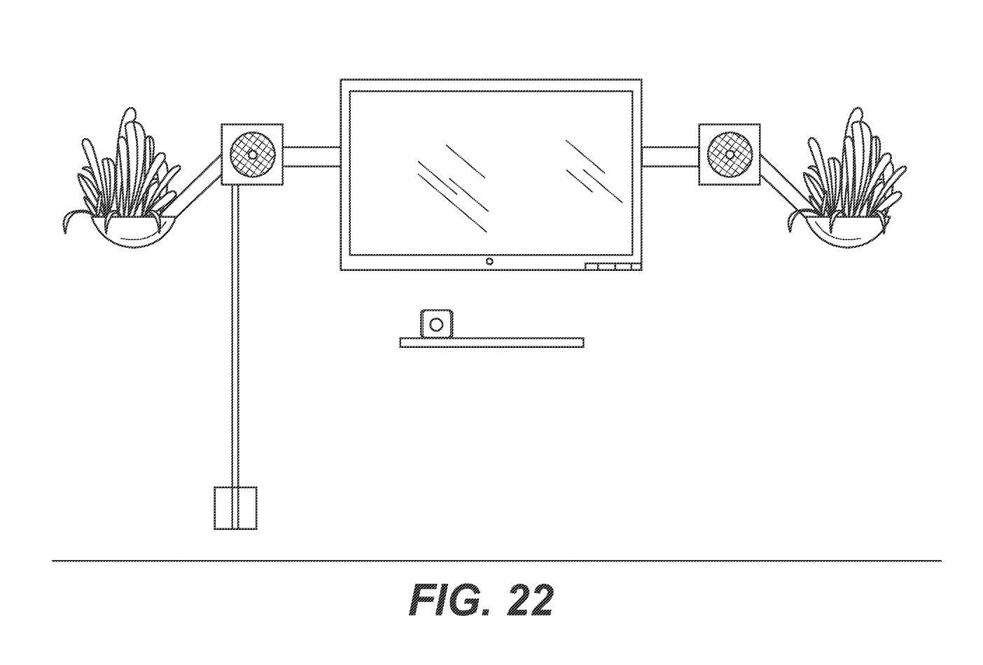

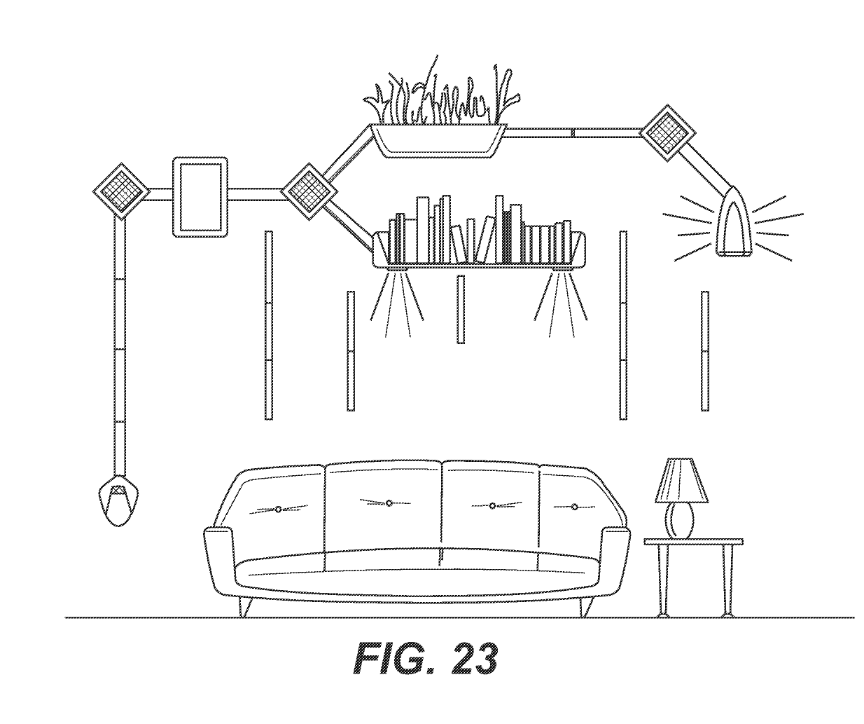

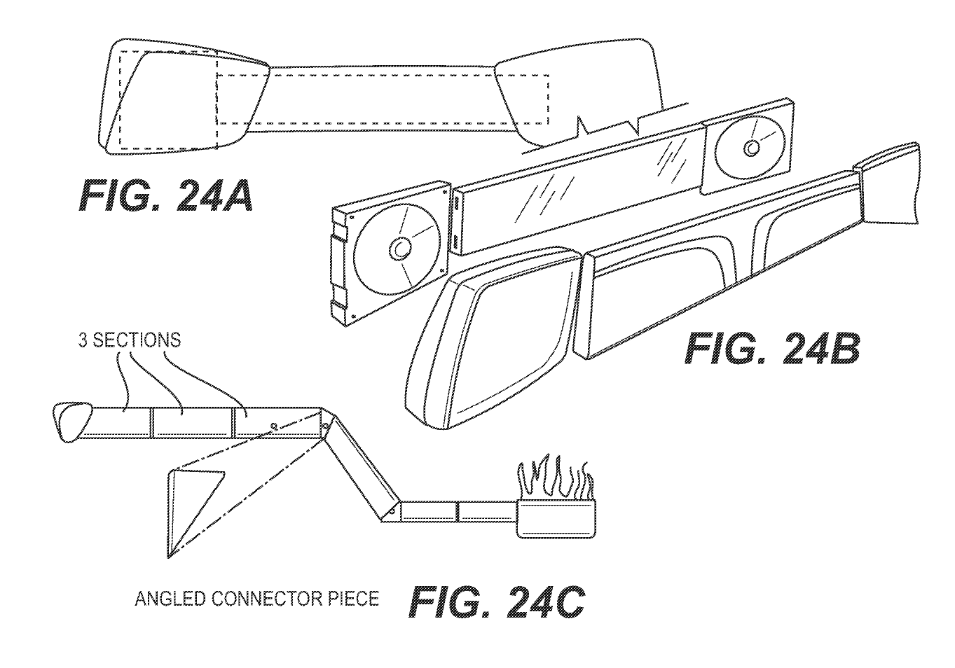

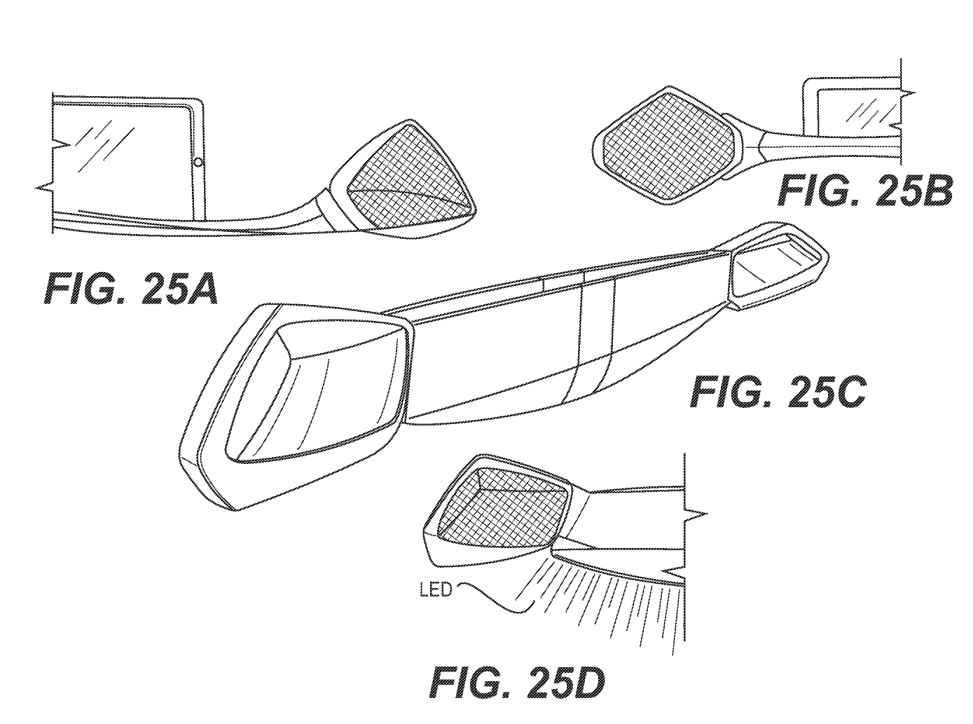

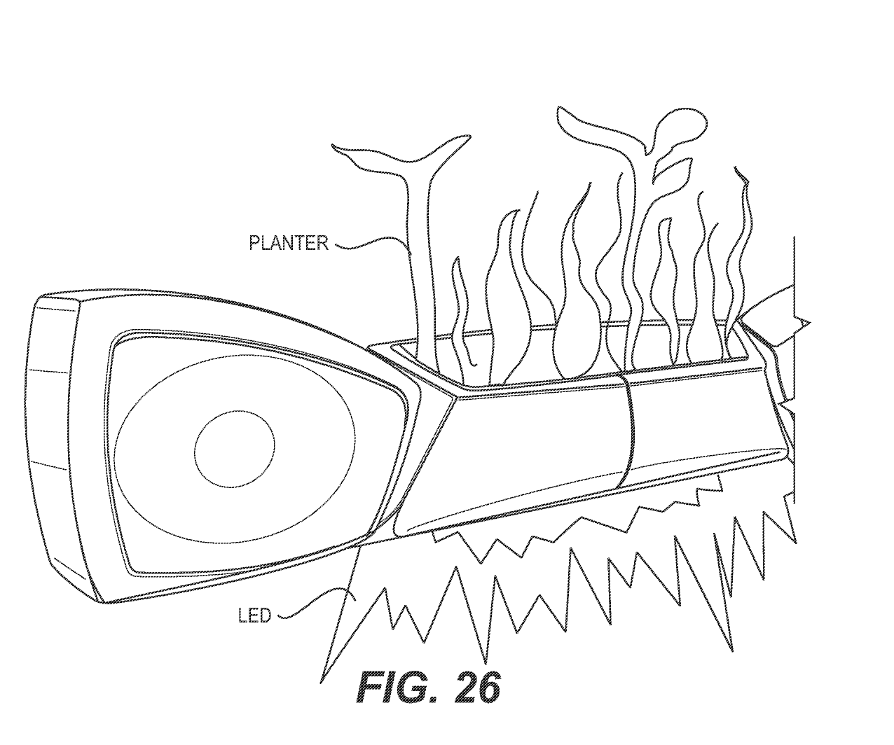

Referring generally to FIGS. 5-26, various aesthetic trim components having different styles or designs are shown, and including speakers, lighting devices, and control modules having different styles or designs are also shown. The modular track features depicted in the example embodiments may include linear arrangements, curves shapes, various angles sections, and the like. Further, the modular wall mounting system may include one or more decor features configured to physically coupled with the modular track features. Examples of decor features that may be physically coupled with the modular track features may include, but are not limited to, shelves, picture frames, wall mounted desks, TV mounting systems, chargers and docking stations (e.g., for rechargeable electronic devices and mobile computing devices), planters, magazine racks, DVD or CD racks and the like. It will be appreciated from the various illustrative example configurations, styles, and designs that a wide array of configurations and arrangements may be achieved consistent with the present disclosure.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. An apparatus comprising:
a control module including a power module configured to be coupled to a line voltage source and to provide a power distribution output, and an audio module configured to receive a source audio input signal and to provide an audio output signal;
a modular track feature including a plurality of power distribution rails configured to be coupled with the power module and one or more audio distribution conductors configured to be coupled with the audio module, at least a portion of the power distribution rails exposed for contact coupling with a power consumption device;
a lighting device configured to physically couple with the modular track feature and electrically couple with at least a portion of the plurality of power distribution rails for powering the lighting device;
a speaker configured to physically couple with the modular track feature and electrically couple with the audio distribution conductors for receiving the audio output signal from the control module.

2. The apparatus of claim 1, wherein the audio module includes an audio amplifier receiving the audio input signal from one or more of a tuner, a CD player, a DVD player; and a digital music player.

3. The apparatus of claim 1, wherein the control module further includes a computing network module.

4. The apparatus of claim 1, wherein the modular track feature includes one or more data distribution lines coupled with the computing network module, the one or more data distribution lines configured to couple with one or more remote computing devices.

5. The apparatus of claim 1, wherein the control module is configured to interact with an external computing device.

6. The apparatus of claim 5, wherein the control module configured to interact with the external computing device is configured to receive streaming audio from the external computing device.

7. The apparatus of claim 5, wherein the control module configured to interact with the external computing device is configured to receive lighting control inputs from the external computing device, the control module configured to control the lighting device based upon the received lighting control inputs.

8. The apparatus of claim 1, wherein the modular track feature comprises a plurality of modular track sections, each of the modular track sections physically and electrically coupleable to one or more adjacent modular track sections.

9. The apparatus of claim 1, wherein the modular track feature includes a plurality of aesthetic trim components removably coupleable to an exterior surface of the modular track feature.

10. The apparatus of claim 1, wherein the plurality of power distribution rails include power distribution rails providing different voltages.

11. The apparatus of claim 1, wherein the plurality of audio distribution conductors include a wiring assembly at least partially disposed within the modular track feature.

12. The apparatus of claim 1, wherein the plurality of audio distribution conductors include a plurality of conductive rails having at least one exposed surface for electrically coupling with the speaker.

13. The apparatus of claim 1, wherein the lighting device includes one or more of a LED light, a fluorescent light, a halogen light, and an incandescent light.

14. The apparatus of claim 1, wherein the modular track feature is configured to be securely mounted to a wall.

15. The apparatus of claim 1, further comprising one or more decor features configured to physically couple with the modular track feature.

16. An apparatus comprising:
a control module including a power module configured to be coupled to a line voltage source and to provide a power distribution output, and a communication module configured to interact with an external computing device;
a modular track feature including a plurality of power distribution rails configured to be coupled with the power module, at least a portion of the power distribution rails exposed for contact coupling with a power consumption device; and
a lighting device configured to physically couple with the modular track feature and electrically couple with at least a portion of the plurality of power distribution rails for powering the lighting device;
wherein the communication module is configured to receive lighting control inputs from the external computing device, the control module configured to control the lighting device based upon the received lighting control inputs.

17. The apparatus according to claim 16, further comprising a plurality of lighting devices configured to be coupled with the modular track feature, and wherein the control module is configured to provide a first control associated with at least a first lighting device and a second control associated with at least a second lighting device.

18. An apparatus comprising:
a control module including an audio module configured to receive a source audio input signal and to provide an audio output signal, the control module configured to interact with an external computing device to receive streaming audio from the external computing device;
a modular track feature including one or more audio distribution conductors at least partially disposed within the modular track feature, the one or more audio distribution conductors configured to be coupled to the audio module; and
a speaker configured to physically couple with the modular track feature and electrically couple with the audio distribution conductors for receiving the audio output signal from the control module.

19. The apparatus of claim 1, wherein the plurality of audio distribution conductors include a wiring assembly at least partially disposed within the modular track feature.

20. The apparatus of claim 1, wherein the plurality of audio distribution conductors include a plurality of conductive rails having at least one exposed surface for electrically coupling with the speaker.
